(19) United States
(12) Patent Application Publication
(10) Pub. No.: US 2004/0076247 A1
(43) Pub. Date: Apr. 22, 2004

(54) Peak-to-average power ratio modifier

(75) Inventors: Ilan Saul Barak, Kfar Saba (IL); Yuval Shalom, Neve Savion (IL); Nir Tal, Haifa (IL)

Correspondence Address: DARBY & DARBY P.C., 805 Third Avenue, New York, NY, 10022, US

(73) Assignee: WISEBAND COMMUNICATIONS LTD.

(21) Appl. No.: 10/277,363

(22) Filed: Oct. 22, 2002

(51) Int. Cl. H04L 27/04; H04L 27/12

(52) U.S. Cl. 375/350

(57) ABSTRACT

A method for processing an input signal having an input peak-to-average (PAR) so as to generate an output signal having an output PAR and a permitted spectral mask. The method includes generating a difference signal proportional to an amount by which the input signal exceeds a predetermined threshold, and filtering the difference signal with a filter having a spectral response that is determined responsively to the permitted spectral mask. The filtered difference signal is subtracted from the input signal to generate the output signal so that the output PAR is adjusted relative to the input PAR. Typically, the output PAR is reduced relative to the input PAR.

### FIELD OF THE INVENTION

The present invention relates generally to high-performance transmitters for communication applications, and specifically to methods and devices for enhancing efficiency of such transmitters.

### BACKGROUND OF THE INVENTION

The Peak-to-Average power Ratio (PAR, sometimes referred to as EPAR—Envelope Peak to Average Ratio) of transmitted signals plays a major role in the design of transmitter circuitry and has a direct impact on the complexity and power consumption of such circuitry. In a transmitter, when the signal amplitude is limited (clipped) to some maximum value due to PAR restrictions, the transmitted signal is distorted, and system performance is degraded. Conversely, the efficiency of analog transmitter circuits is generally inversely proportional to the PAR that the circuits must accommodate. Designing a transmitter for high PAR generally entails excessive use of costly, high-power transistors. As a rule, reduced PAR means higher overall transmitter efficiency and lower cost.

Modern wideband digital transmission standards, however, are typically characterized by inherently high PAR, due to the modulation and multiplexing schemes mandated by these standards. For example, in a Wideband Code Division Multiple Access (WCDMA) cellular base station, the transmitted signal may have PAR in excess of 11 dB. Detailed specifications can be found in “Universal Mobile Telecommunications System (UMTS); Base station conformance testing (FDD),” published by the European Telecommunications Standards Institute (ETSI) as document 3GPP TS 25.141 V3.9.0 (2002-03). In multi-carrier modulation, such as Orthogonal Frequency Division Multiplex (OFDM) signals, used in other wireless and wired communication applications, the PAR values may be even more extreme, typically up to 14 dB. Arbitrarily reducing the PAR of the transmitted signal (hard clipping) causes distortion, leading to reduced system performance, mainly due to spectral contamination of adjacent channels. There is thus a widely-felt need for methods and devices that can enable the PAR of a transmitted signal to be reduced without unduly distorting the signal.

Various methods are known in the art for reducing PAR of transmitted signals. For example, U.S. Pat. No. 6,175,551, whose disclosure is incorporated herein by reference, describes a method and system for reducing PAR by applying peak cancellation to the transmitted signal. When samples of the signal are found to exceed a certain threshold, a time-shifted and scaled reference function is subtracted from a sampled signal interval or symbol in order to reduce the peak signal power. One example of a suitable reference signal cited in this patent is a sinc function or, alternatively, a sinc function multiplied by a windowing function, such as a raised cosine window.

### SUMMARY OF THE INVENTION

It is an object of some aspects of the present invention to provide methods and devices for controlling the PAR of a transmitted signal.

In preferred embodiments of the present invention, a transmitter comprises a PAR adjustment circuit, which typically operates on baseband or Intermediate Frequency (IF) input signals prior to up-conversion and amplification of the signals for transmission. The PAR adjustment circuit is typically used to reduce the PAR of the transmitted signal. The circuit generates an internal difference signal, which is proportional to the amount by which the input signal exceeds a predetermined threshold. The difference signal is filtered, in order to generate a correction signal whose bandwidth is approximately equal to or less than the input signal bandwidth. The correction signal is subtracted from the input signal, thus generating an output signal with reduced PAR and unaltered bandwidth. By properly choosing the threshold of the difference signal, the PAR of the output signal may be reduced to a desired target level while distortion of the signal modulation is maintained within an acceptable error limit.

By comparison with methods of PAR reduction known in the art, such as that described in the above-mentioned U.S. Pat. No. 6,175,551, the present invention has the advantage of simplicity and complete independence from the signal generation mechanism. According to the present invention, the difference signal is generated from the input signal itself, without requiring a separate reference signal or timing adjustment to the source signal. Thus, the PAR reduction circuit of the present invention operates continuously and can even be implemented as an add-on to existing transmitter circuits.

In an alternative embodiment, the PAR adjustment circuit generates the difference signal so as to compensate for subsequent amplitude compression by the power amplifier of the transmitter. For this purpose, the circuit may include a lookup table or implement a mathematical function that is essentially inverse to the AM-AM amplitude distortion of the power amplifier.

Although preferred embodiments are described herein with reference to certain types of wireless transmitters, and particularly to base station transmitters, the principles of the present invention may similarly be applied to transmitters of other kinds, both wireless and wired, as well as in other contexts in which PAR reduction is mandated. For example, transmitters using PAR reduction in accordance with the present invention may be used for multi-carrier wireless transmission, as well as in landline modems and cable television systems.

There is therefore provided, in accordance with a preferred embodiment of the present invention, a method for processing an input signal having an input peak-to-average (PAR) so as to generate an output signal having an output PAR and a permitted spectral mask, the method including:

generating a difference signal proportional to an amount by which the input signal exceeds a predetermined threshold;

filtering the difference signal with a filter having a spectral response that is determined responsively to the permitted spectral mask; and

subtracting the filtered difference signal from the input signal to generate the output signal so that the output PAR is adjusted relative to the input PAR.

Preferably, the output PAR is reduced relative to the input PAR, and generating the difference signal includes clipping the input signal, and subtracting the clipped input signal from the input signal. Alternatively, generating the difference signal includes producing the difference signal responsively to subsequent PAR compression in the output signal.

Further preferably, the filter has a bandwidth approximately equal to or less than a permitted bandwidth of the permitted spectral mask.

Preferably, the input signal includes a baseband signal, and filtering the difference signal includes applying a low-pass filter to the difference signal. Alternatively, filtering the difference signal includes applying a bandpass filter to the difference signal, and the input signal may include an intermediate frequency (IF) signal.

In a preferred embodiment, filtering the difference signal includes applying a complex filter, such as a polyphase filter.

Optionally, filtering the difference signal includes detecting a spectral characteristic of the input signal, and setting the spectral response of the filter responsively to the detected spectral characteristic.

In another preferred embodiment, the filter has a non-symmetrical frequency response. In still another preferred embodiment, filtering the difference signal includes applying a minimum phase filter. In yet another preferred embodiment, filtering the difference signal includes applying a finite, impulse response (FIR) filter.

Preferably, the input signal includes a combined signal, generated by modulating multiple data streams on different carrier frequencies and combining the multiple data streams into the combined signal.

Further preferably, subtracting the filtered difference signal includes adjusting a delay of at least one of the filtered difference signal and the input signal prior to subtracting the signals.

The input signal and difference signal may be digital signals or analog signals. In a preferred embodiment, the input signal and difference signal are complex signals, having respective in-phase and quadrature components.

There is also provided, in accordance with a preferred embodiment of the present invention, apparatus for processing an input signal having an input peak-to-average (PAR) so as to generate an output signal having an output PAR and a permitted spectral mask, the apparatus including:

a clipping circuit, which is adapted to generate a difference signal proportional to an amount by which the input signal exceeds a predetermined threshold;

a filter, which is adapted to filter the difference signal with a spectral response that is determined responsively to the permitted spectral mask; and

an adder circuit, which is coupled to subtract the filtered difference signal from the input signal to generate the output signal so that the output PAR is reduced relative to the input PAR.

Preferably, the clipping circuit includes a limiter, which is adapted to generate a clipped input signal, and an adder, which is adapted to subtract the clipped input signal from the input signal. The limiter may include a complex magnitude limiting circuit or a saturable amplifier.

Preferably, the apparatus includes a delay circuit, which is adapted to delay the input signal for input to the adder circuit so as to synchronize timing of the filtered difference signal and of the input signal prior to subtracting the signals.

There is additionally provided, in accordance with a preferred embodiment of the present invention, a transmitter, for transmitting an output signal having a predetermined output peak-to-average (PAR) and a permitted spectral mask, the transmitter including:

data modulation circuitry, which is coupled to modulate and multiplex together multiple input data streams so as to generate a combined input signal having an input PAR;

a PAR reduction circuit, coupled to receive the combined input signal and including:

a clipping circuit, which is adapted to generate a difference signal proportional to an amount by which the combined input signal exceeds a predetermined threshold;

a filter, which is adapted to filter the difference signal with a spectral response that is determined responsively to the permitted spectral mask; and

an adder circuit, which is coupled to subtract the filtered difference signal from the combined input signal to generate the output signal so that the output PAR is reduced relative to the input PAR; and

radio frequency (RF) transmission circuitry, coupled to receive the output signal from the PAR reduction circuit and to up-convert and amplify the, output signal for transmission to a receiver.

The present invention will be more fully understood from the following detailed description of the preferred embodiments thereof, taken together with the drawings in which:

### BRIEF DESCRIPTION OF THE DRAWINGS

FIG. 1 is a block diagram that schematically illustrates a wireless base station transmitter, in accordance with a preferred embodiment of the present invention;

FIG. 2 is a block diagram that schematically illustrates a PAR reduction circuit, in accordance with a preferred embodiment of the present invention;

FIGS. 3A-3D are schematic plots of signal power versus time at a number of points in the circuit of FIG. 2;

FIGS. 4A-4D are schematic plots of signal power spectral density against frequency at a number of points in the circuit of FIG. 2; and

FIG. 5 is a schematic plot of signal power spectral density against frequency, illustrating another preferred embodiment of the present invention.

### DETAILED DESCRIPTION OF PREFERRED EMBODIMENTS

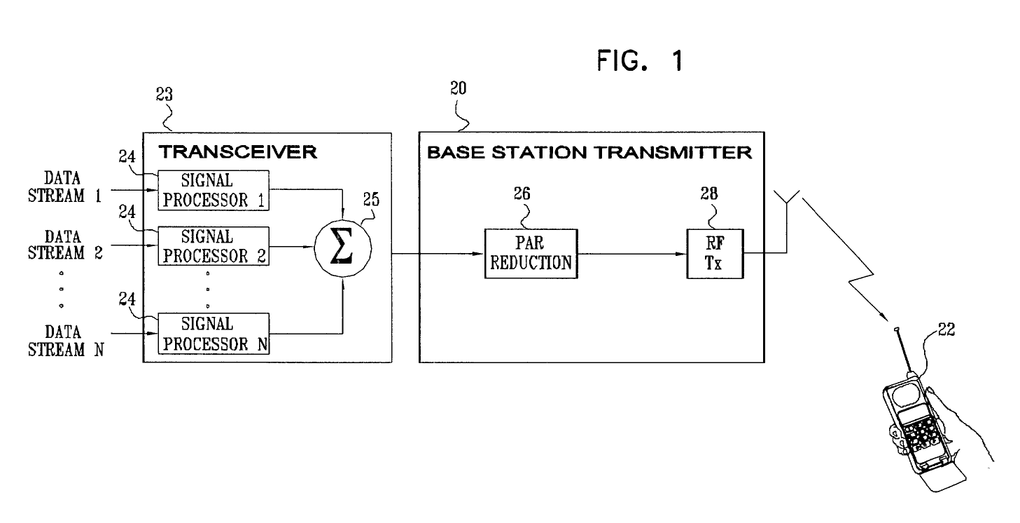

FIG. 1 is a block diagram that schematically illustrates a base station transmitter 20, in accordance with a preferred embodiment of the present invention. The transmitter communicates with a mobile receiver 22 (or, more typically, with many mobile receivers simultaneously). Standard elements of transmitter 20 that are not essential to an understanding of the present invention are omitted from the figure.

Transmitter 20 typically receives a composite RF signal from a base station transceiver 23, which encodes and combines data streams from multiple sources for transmission to mobile receivers. Transceiver 23 and transmitter 20 may operate, for example, as part of a WCDMA system, as mentioned above, or alternatively may use other multiplexing and modulation schemes known in the art, whether single carrier or multi-carrier, such as OFDM or time-domain multiplexing (TDM), and various types of amplitude-, frequency- and phase-shift keying. Typically, transceiver 23 comprises multiple signal processing channels 24, each of which processes one of the input data streams. The processing functions of each of channels 24 generally include applying a spectral windowing function, such as a root raised cosine (RRC) filter, to the respective data stream. This filtering ensures that the bandwidth of the signal complies with a power spectral density (PSD) mask mandated by the applicable standards. A summer 25 then merges the streams into a combined signal for input to transmitter 20.

Base station transmitter 20 comprises a PAR reduction circuit 26, which operates on the input signal to reduce the peak signal power, as described in detail hereinbelow. The operation of the PAR reduction circuit conditions the signal for subsequent amplification by a power amplifier (not shown) in a radio frequency (RF) transmission circuit 28. The input to circuit 26 is typically the combined signal output by transceiver 23, as mentioned above, which may be an analog complex baseband signal, a digital signal, or an up-converted intermediate-frequency (IF) signal or RF signal. Circuit 26 operates by reducing the level of peaks of the input signal that exceed a preset power threshold, in such a way that the bandwidth of the signal is not significantly affected. Reducing the peaks necessarily introduces a certain amount of distortion into the signal, depending on the setting of the threshold. (Typically, the lower the threshold, the lower will be the PAR of the output signal from circuit 26, but the greater will be the distortion.) Therefore, the threshold and other parameters of circuit 26 are preferably set to levels that will achieve the target PAR while still ensuring that the modulation accuracy of the output signal remains within the bounds permitted by applicable standards and design criteria. For example, the WCMDA standard mentioned above requires the Error Vector Magnitude (EVM) of the transmitter to be no greater than 17.5%.

Radio frequency (RF) transmission circuit 28 up-converts the reduced-PAR output signal of circuit 26, and transmits the signal to mobile receiver 22. Typically, PAR reduction circuit 26 operates in the digital domain, and RF transmission circuit 28 converts the reduced-PAR output signal to analog signals. Alternatively, PAR reduction circuit 26 may operate in the analog domain, on baseband or IF signals, and may provide an analog output to transmission circuit 28. Whether digital or analog, the baseband input to circuit 26 may comprise a single data stream or signal, or it may be a complex signal comprising separate in-phase (I) and quadrature (Q) components. The PAR reduction circuit may be implemented using either digital or analog circuit elements, as appropriate. These elements may be discrete components, or some or all of the elements may alternatively be combined in a single integrated circuit, such as an Application Specific Integrated Circuit (ASIC).

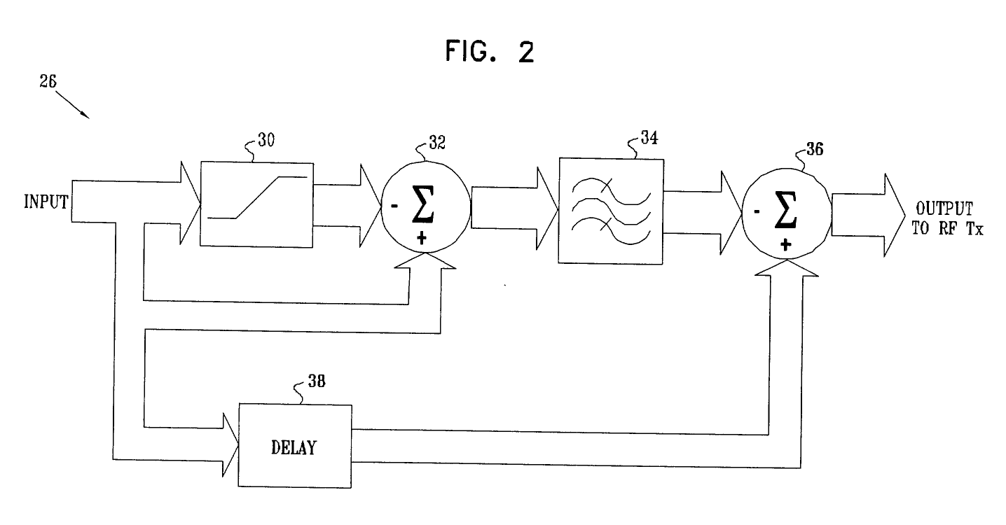

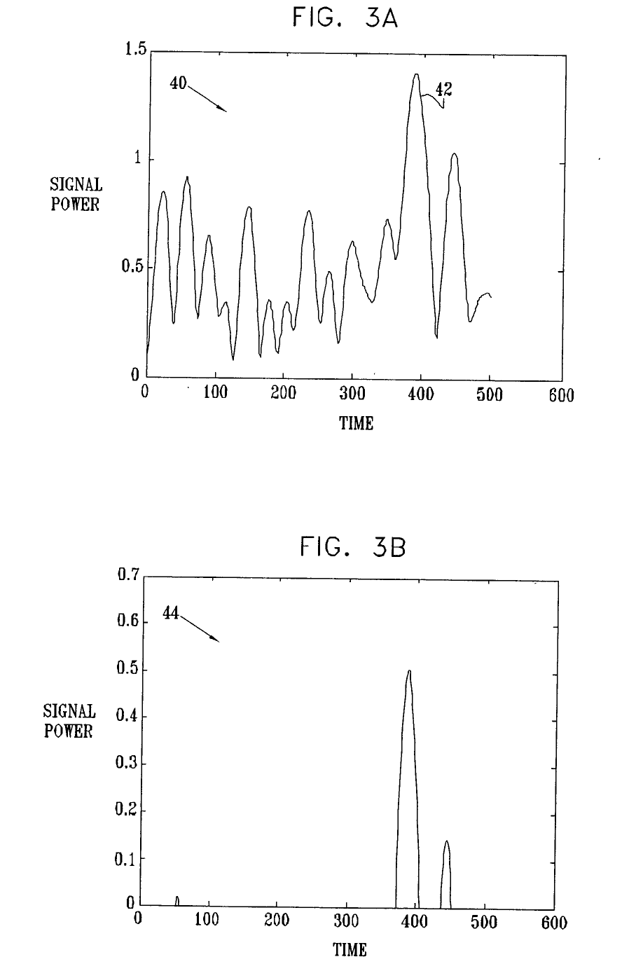

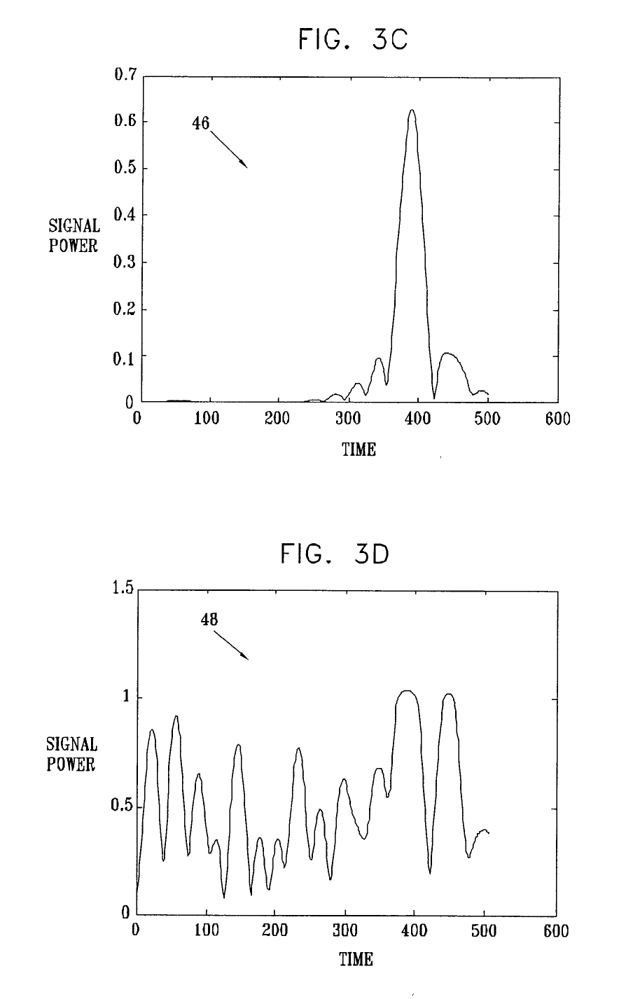

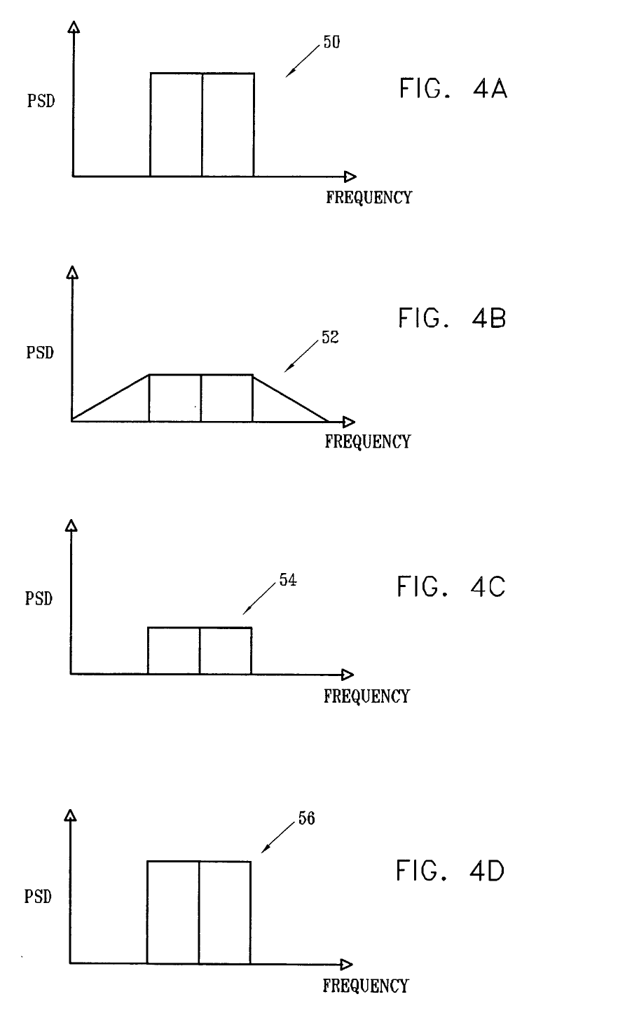

Reference is now made to FIG. 2, as well as to FIGS. 3A-3D and 4A-4D, which schematically illustrate the operation of PAR reduction circuit 26, in accordance with a preferred embodiment of the present invention. FIG. 2 is a block diagram of the circuit. FIGS. 3A-3D show signal power levels over time, while FIGS. 4A-4D show the power spectral density (PSD) of the signals as a function of frequency, at different points in the circuit. The scales in both figures are arbitrary.

A hard limiter 30 clips the input signal received by circuit 26 at a predetermined threshold. The threshold is chosen based on the maximum PAR to be allowed at the input to RF transmission circuit 28. FIG. 3A shows an input signal 40 with a peak 42 that is above the clipping threshold of limiter 30, which is set to about 0.9 on the scale of FIGS. 3A-3D. A frequency spectrum 50 of the input signal, shown in FIG. 4A, is typically symmetrical and bound within limits applied by modulation circuitry 24. (In this example, the spectrum is symmetrical around a center frequency, located between the two vertical bars. The signal may be a baseband signal, in which case the center frequency is zero, or it may be an IF signal, in which case the center frequency is the IF carrier frequency. Circuit 26 can also be configured to handle non-symmetrical spectra, as described below.) Typically, input signal 40 is a sequence of digital samples, and limiter 30 and the other elements of circuit 26 are digital components. Alternatively, for analog domain processing, limiter 30 may comprise, for example, a complex magnitude limiting circuit or a saturated amplifier, as are known in the art.

An adder 32 subtracts the clipped signal from the original input signal, to generate a difference signal 44, as shown in FIG. 3B. The peaks of the difference signal correspond in magnitude and phase to the excursions of input signal 40 above the threshold. Due to the non-linear clipping operation, however, signal 44 has a spectrum 52, shown in FIG. 4B, which is wider than spectrum 50 of the input signal. Subtracting signal 44 from input signal 40 would give an output signal with bandwidth in excess of the allowed PSD mask of transmitter 20.

Therefore, difference signal 44 is input to a filter 34, whose bandwidth corresponds to the allowed PSD of the signal, i.e., bandwidth approximately equal to or less than the bandwidth of the input signal. Various possible implementations of filter 34 are described below. Filter 34 outputs a filtered difference signal 46, as shown in FIG. 3C, with reduced bandwidth and with magnitude roughly equal to or slightly greater than the amount by which input signal 40 exceeds the threshold. FIG. 4C shows a filtered spectrum 54 of signal 46.

A second adder 36 subtracts filtered difference signal 46 from input signal 40. A delay line 38 delays the input signal sufficiently so that it is in phase with the filtered difference signal at adder 36. Adder 36 thus generates an output signal 48, shown in FIG. 3D, with reduced PAR and with a spectrum 56, shown in FIG. 4D, comparable to that of the input signal.

In many typical transmitters, such as WCDMA transmitters, filter 34 comprises a RRC filter, similar to the RRC filter used in spectral shaping of the output of modulation circuitry 24. As a specific example, assume the input to PAR reduction circuit 26 is a symmetrical baseband signal, with half bandwidth of 10 MHz (corresponding to four adjacent WCDMA carriers) and PAR of 11 dB. Let the target PAR in the output signal from circuit 26 be 7.5 dB. The clipping level of limiter 30 is preferably set to about 95% of the target level, i.e., to about 4 dB below the peak input signal level. Filter 34 is a RRC low-pass filter with bandwidth of 9.4 MHz, or slightly less, as measured 3 dB down from the peak filter response. The filter is preferably implemented as a minimum phase filter, most preferably a digital finite impulse response (FIR) filter. The inventors obtained good results at a sample rate of 400 MHz using a FIR filter with 501 taps, with the rolloff of the RRC filter set to 0.22 and a hanning window of appropriate length to smooth the frequency response. The filter coefficients are most preferably set to give a gain of two, so that the peaks in filtered difference signal 46 are higher than the corresponding peaks in the input signal. As a result, all peaks are fully attenuated by adder 36. The output signal from transmitter 20, however, is still within the 17.5% EVM limit of WCDMA.

Alternatively, other filter types may be used. For example, filter 34 may comprise an analog filter, or it may comprise a digital infinite impulse response (IIR) filter. Further alternatively, the filter may comprise a bandpass filter, rather than a low-pass filter as described above. The bandpass configuration is needed particularly when the input signal to PAR reduction circuit 26 is an IF signal, rather than a baseband signal.

In other cases, a bandpass filter with multiple symmetrical or non-symmetrical lobes may be required when the spectrum of the input signal to PAR reduction circuit 26 includes multiple, non-contiguous frequency bands. Various types of bandpass filters may be useful for this purpose. For example, a network of asymmetric polyphase filters, as described by Galal et al., in “RC Sequence Asymmetric Polyphase Networks for RF Integrated Transceivers,” IEEE Transactions on Circuits and Systems-II: Analog and Digital Signal Processing 47:1 (January, 2000), pages 18-27, can be used to form any arbitrary asymmetric frequency response. As another example, a minimum-phase, complex FIR filter may be used, as described by Damera-Venkata et al., in “Design of Optimal Minimum-Phase Digital FIR Filters Using Discrete Hilbert Transforms,” IEEE Transactions on Signal Processing 48:5 (May, 2000), pages 1491-1495. Both of these articles are incorporated herein by reference. As still another example, the inventors found that for two WCDMA carriers, spaced 15 MHz apart (each carrier signal having a bandwidth of 5 MHz), a Butterworth bandpass filter of order 11 gave good results. The two lobes of the filter were adjusted to be 1.6 MHz wide, centered at +5 MHz an −5 MHz, respectively. The relatively narrow bandwidth of the filter lobes, by comparison with the wider bandwidth of the carrier bands, is helpful in ensuring that the output signal from circuit 26 remains within the PSD limitations of the WCDMA standard.

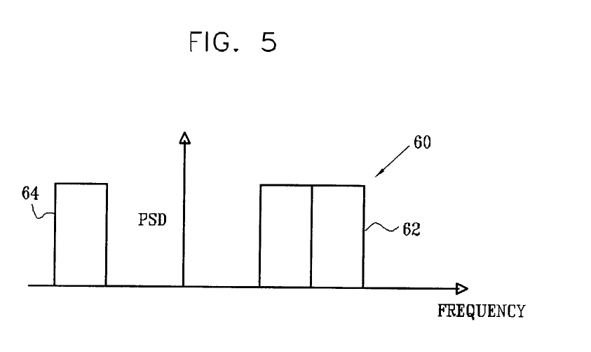

FIG. 5 is a schematic plot of signal PSD against frequency, illustrating another preferred embodiment of the present invention. In this case, the input signal to PAR reduction circuit 26 has a non-symmetrical spectrum 60, including a broad lobe 62 and a narrow lobe 64, separated by a band gap. In this case, filter 34 preferably comprises a superposition of complex low-pass filters, chosen to match the non-symmetrical spectrum of the input signal.

The filter type and frequency response can be set automatically if the input signal to be processed spectrum is detected. For this purpose, transmitter 20 may include a detection circuit (not shown), which identifies the center frequencies of the signal to be processed, and sets the filter parameters accordingly.

Although PAR reduction circuit 26 is shown and described hereinabove in the context of base station transmitter 20, it will be apparent to those skilled in the art that similar PAR reduction circuits may be used in wireless transmitters of other types, such as multi-carrier wireless transmitters, and in landline modems, as well as in other types of equipment in which reduced PAR is important, such as cable television systems. It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for processing an input signal having an input peak-to-average (PAR) so as to generate an output signal having an output PAR, different from the input PAR, and a permitted spectral mask, the method comprising:
generating a difference signal proportional to an amount by which the input signal exceeds a predetermined threshold;
filtering the difference signal with a filter having a spectral response that is determined responsively to the permitted spectral mask; and
subtracting the filtered difference signal from the input signal to generate the output signal so that the output PAR is adjusted relative to the input PAR.

2. A method according to claim 1, wherein generating the difference signal comprises producing the difference signal so that the output PAR is reduced relative to the input PAR.

3. A method according to claim 2, wherein producing the difference signal comprises clipping the input signal, and subtracting the clipped input signal from the input signal.

4. A method according to claim 1, wherein generating the difference signal comprises producing the difference signal responsively to subsequent PAR compression in the output signal.

5. A method according to claim 1, wherein the filter has a filter bandwidth that is approximately equal to or less than a permitted bandwidth of the permitted spectral mask.

6. A method according to claim 1, wherein the input signal comprises a baseband signal, and wherein filtering the difference signal comprises applying a low-pass filter to the difference signal.

7. A method according to claim 1, wherein filtering the difference signal comprises applying a bandpass filter to the difference signal.

8. A method according to claim 7, wherein the input signal comprises an intermediate frequency (IF) signal.

9. A method according to claim 1, wherein filtering the difference signal comprises applying a complex filter.

10. A method according to claim 9, where the complex filter comprises a polyphase filter.

11. A method according to claim 1, wherein filtering the difference signal comprises:
detecting a spectral characteristic of the input signal; and
setting the spectral response of the filter responsively to the detected spectral characteristic.

12. A method according to claim 1, wherein the spectral response comprises a non-symmetrical frequency response.

13. A method according to claim 1, wherein filtering the difference signal comprises applying a minimum phase filter.

14. A method according to claim 1, wherein filtering the difference signal comprises applying a finite impulse response (FIR) filter.

15. A method according to claim 1, wherein the input signal comprises a combined signal, generated by modulating multiple data streams on different carrier frequencies and combining the multiple data streams into the combined signal.

16. A method according to claim 1, wherein subtracting the filtered difference signal comprises adjusting a delay of at least one of the filtered difference signal and the input signal prior to subtracting the signals.

17. A method according to claim 1, wherein the input signal and difference signal are digital signals.

18. A method according to claim 1, wherein the input signal and difference signal are analog signals.

19. A method according to claim 1, wherein the input signal and difference signal are complex signals, having respective in-phase and quadrature components.

20. Apparatus for processing an input signal having an input peak-to-average (PAR) so as to generate an output signal having an output PAR and a permitted spectral mask, the apparatus comprising:
a clipping circuit, which is adapted to generate an difference signal proportional to an amount by which the input signal exceeds a predetermined threshold;
a filter, which is adapted to filter the difference signal with a spectral response that is determined responsively to the permitted spectral mask; and
an adder circuit, which is coupled to subtract the filtered difference signal from the input signal to generate the output signal so that the output PAR is adjusted relative to the input PAR.

21. Apparatus according to claim 20, wherein the clipping circuit is adapted to generate the difference signal so that the output PAR is reduced relative to the input PAR.

22. Apparatus according to claim 21, wherein the clipping circuit comprises a limiter, which is adapted to generate a clipped input signal, and an adder, which is adapted to subtract the clipped input signal from the input signal.

23. Apparatus according to claim 22, wherein the limiter comprises a complex magnitude limiting circuit.

24. Apparatus according to claim 22, wherein the limiter comprises a saturable amplifier.

25. Apparatus according to claim 20, wherein the clipping circuit is adapted to generate the difference signal so as to compensate for PAR compression in the output signal.

26. Apparatus according to claim 20, wherein the filter has a filter bandwidth is approximately equal to or less than a permitted bandwidth of the permitted spectral mask.

27. Apparatus according to claim 20, wherein the input signal comprises a baseband signal, and wherein the filter comprises a low-pass filter.

28. Apparatus according to claim 20, wherein the filter comprises a bandpass filter.

29. Apparatus according to claim 28, wherein the input signal comprises an intermediate frequency (IF) signal.

30. Apparatus according to claim 20, the filter comprises a complex filter.

31. Apparatus according to claim 20, wherein the filter has a non-symmetrical frequency response.

32. Apparatus according to claim 20, wherein the filter comprises a minimum phase filter.

33. Apparatus according to claim 20, wherein the filter comprises a finite impulse response (FIR) filter.

34. Apparatus according to claim 20, wherein the input signal comprises a combined signal, generated by modulating multiple data streams on different carrier frequencies and combining the multiple data streams into the combined signal.

35. Apparatus according to claim 20, and comprising a delay circuit, which is adapted to delay the input signal for input to the adder circuit so as to synchronize timing of the filtered difference signal and of the input signal prior to subtracting the signals.

36. Apparatus according to claim 20, wherein the input signal and difference signal are digital signals.

37. Apparatus according to claim 20, wherein the input signal and difference signal are analog signals.

38. Apparatus according to claim 20, wherein the input signal and difference signal are complex signals, having respective in-phase and quadrature components.

39. A transmitter, for transmitting an output signal having a predetermined output peak-to-average (PAR) and a permitted spectral mask, the transmitter comprising:
data modulation circuitry, which is coupled to modulate and multiplex together multiple input data streams so as to generate a combined input signal having an input PAR;
a PAR adjustment circuit, coupled to receive the combined input signal and comprising:
a clipping circuit, which is adapted to generate a difference signal proportional to an amount by which the combined input signal exceeds a predetermined threshold;
a filter, which is adapted to filter the difference signal with a spectral response that is determined responsively to the permitted spectral mask; and
an adder circuit, which is coupled to subtract the filtered difference signal from the combined input signal to generate the output signal so that the output PAR is adjustment relative to the input PAR; and
radio frequency (RF) transmission circuitry, coupled to receive the output signal from the PAR reduction circuit and to up-convert and amplify the output signal for transmission to a receiver.

40. Apparatus according to claim 39, wherein the PAR adjustment circuit is adapted to reduce the output PAR relative to the input PAR.
